(19) United States
(12) Patent Application Publication
(10) Pub. No.: US 2011/0062353 A1
(43) Pub. Date: Mar. 17, 2011

(54) IRRADIATION SYSTEMS

(75) Inventor: David E. Cooper, Glendora, CA (US)

(73) Assignee: Ushio America, Inc.

(21) Appl. No.: 12/562,047

(22) Filed: Sep. 17, 2009

(51) Int. Cl. G01J 1/00

(52) U.S. Cl. 250/503.1

(57) ABSTRACT

In accordance with the present invention, there are provided actively pumped, low energy devices, which allow cathode and/or window to be replaced or exchanged as required by conditions of use and application (as a result of the presence of an interchangeable cathode and interchangeable window), without necessitating replacement of vacuum chamber, or other parts. Such interchangeability greatly expands the utility of the electron device in scientific and industrial applications, besides addressing such issues as wear and tear, restoration and upgrading of performance, of the device internal components, it provides the ability to match the device output energy and power to a wide variety of scientific and practical applications. Such features in a single portable device also provide a cost effective and practical way to deliver electrons to an object or other device in a manner that is independent of the atmosphere of the object or device itself.

### FIELD OF THE INVENTION

The present invention relates to novel Electron Beam (Ebeam) sources and uses thereof.

### BACKGROUND OF TILE INVENTION

Historically Ebeam sources have been built as self enclosed systems that have one window design and a fixed output power. Currently, the available sources for electron beams are large, bulky instruments that are not user friendly. Indeed, because prior art systems are very bulky (and consequently, hard to move), they are generally mounted in place, which does not allow for flexibility of application. A large, bulky system which is fixed in place cannot easily be moved. A consequence of this is that the system is not utilitarian and can only be used for the application for which it is installed.

Another problem with prior art Ebeam sources is that the systems are not simple to maintain. Not only are current systems complex, they also present challenges in terms of access thereto for service since the systems are typically bulky in nature. In addition, most of the prior art Ebeam sources require significant time and effort to maintain; for example, equipment failures require return of the equipment to the manufacturer or a specially trained maintenance team to do on-site repairs.

These are significant limitations of the ability of Ebeam systems to make significant penetration into a number of markets such as the curing market. Indeed, there are a number of problems with the above-described Ebeam systems. One problem is the lack of ability to change the window. Current systems have fixed window design with one type of cover on the window. This limits the ability to operate the Ebeam system at various powers. A consequence of the fixed window is a lack of flexibility of application of a given Ebeam source.

### SUMMARY OF THE INVENTION

In accordance with the present invention, there are provided actively pumped, low energy devices, which allow cathode and/or window replacement or exchange as required by conditions of use and application (as a result of the presence of an interchangeable cathode and interchangeable window), without necessitating replacement of vacuum chamber, or other parts.

Such interchangeability greatly expands the utility of the electron device in scientific and industrial applications, besides addressing such issues as wear and tear, restoration and upgrading of performance, of the device internal components, it provides the ability to match the device output energy and power to a wide variety of scientific and practical applications. Such features in a single portable device also provide a cost effective and practical way to deliver electrons to an object or other device in a manner that is independent of the atmosphere of the object or device itself.

Invention Ebeam sources provide the ability to change windows and change power levels. In addition, invention Ebeam sources are of greatly reduced complexity, relative to prior art Ebeam sources, and therefore benefit from ease of maintenance which can be carried out by any person with ordinary level of mechanical skill.

Yet another advantage of the invention Ebeam systems is the fact that such systems are small and easily transported. Moreover, the relatively small size and transportability of invention Ebeam systems, and the ease with which such systems can be maintained facilitates use thereof in a variety of applications and under a variety of conditions.

### BRIEF DESCRIPTION OF THE FIGURES

FIG. 1 provides schematic of an exemplary Ebeam source according to the invention.

### DETAILED DESCRIPTION OF THE INVENTION

In accordance with one aspect of the present invention, there are provided Electron Beam assemblies comprising:

(a) a sealable tube;
(b) a cathode assembly;
(c) a source of electrical current for said cathode assembly; and
(d) an optional window assembly;
wherein said sealable tube has at least one opening for receiving said cathode assembly, at least one vacuum port, and optionally, at least one opening for receiving said window assembly,
wherein said cathode assembly is reversibly attachable to said sealable tube,
wherein said source of electrical current is reversibly attachable to said cathode assembly, and
wherein said window assembly, when present, is reversibly attachable to said sealable tube.
   Thus, in accordance with the present invention, both the cathode assembly and the window assembly are reversibly attached to the sealable tube (e.g., a gun body).

In accordance with another aspect of the present invention, there are provided Ebeam sources that comprise a tube body, a window, a cathode, a vacuum system and a power supply. The source is designed to allow easy changes of the power supply, the cathode assembly, and/or the window by a person of ordinary mechanical skills. The design of the system is such that the system is utilitarian in design and function.

The irradiation system of this invention can have a wide range of output energies, typically falling in the range of about 0.001 to 1 million electron volts, with preferred output energies falling in the range of about 0.1 up to about 100,000 electron volts; and output energies in the range of about 1 up to about 100,000 electron volts being especially preferred.

In one embodiment, the irradiation system of the present invention is operated with vacuum inside the sealed tube. A flange, or other means for reversible attachment of the window, can be present in which case the exposure area can have any desired atmosphere. In another embodiment, the Electron beam system can be operated without the window, wherein the exposure chamber and the Ebeam system are both preferably maintained under vacuum conditions.

With respect to the sealable tube (e.g., gun body), a wide variety of materials can be used therefore, so long as such materials are compatible with the use of Ebeam irradiation. Exemplary materials contemplated for use herein include metals such as stainless steel and aluminum; polymeric materials such as Vespel or PEEK, ceramics such as alumina or silica, and the like.

If the window assembly is present in the irradiation system, a wide variety of materials are contemplated as windows for the operation of the invention Ebeam system. The window is preferably made of materials suitable for electron transmission. The materials that can be used as windows are preferably transparent to electrons for use in the energy range at which the irradiation system is to be operated. These materials are generally materials with low electron density in the body of the material so as to allow easy transmission of the electrons therethrough.

There is no limitation on the materials selected for use herein other than the requirement that such materials must be capable of holding a vacuum and be able to feed through high voltage. Exemplary materials for such purpose include PEEK, which is excellent for this type of application. These materials can include metallic elements, non-metallic elements, organic compounds, inorganic compounds, conducting polymers, and the like.

Examples of suitable metallic compounds include aluminum, titanium, silicon, tantalum, and the like.

Examples of suitable non-metallic elements include carbon, graphite, diamond, diamond-like carbon, and the like.

Exemplary organic polymers contemplated for use herein include mylar and kapton, as well as metalized versions of these polymers.

Exemplary inorganic materials contemplated for use herein include mica, boron nitride, silicon carbide, alumina, garnet, sapphire, ruby, magnesium fluoride, calcium fluoride, synthetic fused silica, silicon dioxide, doped synthetic fused silica, and the like, as well as metalized versions of these materials.

Another class of materials that could be used is conducting polymers such as polythiophene, polyaniline, polyacetylene, and the like, as well as substituted analogues thereof.

The reversibly attached window assembly can be connected to the sealable tube in a variety of ways, e.g., using any suitable connecting mechanism, such as, for example, a flange system such as KF or conflat flange design which is known to those familiar with flange construction, with or without the use of knife edges, metallic gasket(s), O-rings, and the like.

The thickness of the window material can vary. Depending on the material used the thickness may be different to produce optimal electron transparency. In accordance with the present invention, it has been determined that the optimal thickness ranges from about 0.05 microns up to about 20 microns, although thicknesses in the range of about 0.5 up to about 10 microns can be employed herein. Materials in the preferred thickness range can appear as thin translucent films to films that completely block normal light transmission. Presently preferred range for the thickness of the window material falls in the range of about 2-8 microns, depending on the density of the material to the electron transmission.

In the present embodiment the window material is mounted on the flange using standard foil or film mounting technologies. The support for the window material can be a design to allow control of the electrons through the opening. The design can be any achievable geometric shape that allows electron transmission and film support. For example, the design can be round, square, rectangular, triangular, slotted, bifurcated slots, and the like. The consideration for selection of the geometry is the film thickness, desired electron pattern and the desired open area of the window support.

The irradiation system is generally used under vacuum conditions; therefore, it is preferable that the sealable tube be made of appropriate materials for the high vacuum used for electron production. Such materials can include metals, ceramics, composites, and the like. In fact the scalable tube may be prepared from a combination of the materials. Exemplary materials can be metals such as stainless steel and aluminum; polymeric materials such as Vespel or PEEK, ceramics such as alumina or silica, and the like.

The irradiation system contemplated herein can have a number of sources of electrons such as field emission, thermionic, plasma, nanotubes, or the like. The thermionic system typically has a cathode assembly as the electron source. The cathode assembly is typically prepared from materials known to those skilled in the art, generally of vacuum compatible construction. Examples of exemplary thermionic emission sources include tungsten and tantalum wires and alloys of these materials. The emission source is typically connected to the high voltage power supply through a series of connectors including cables. The emission source and the high voltage supply can be connected together through a reversibly attached flange which can include KF and conflat flange designs. For high voltage applications, a suitable number of high voltage connectors will typically be used to have optimal performance of the electron emission source. Examples of such high voltage feed through can include spark plugs or other ceramic (such as alumina) or plastic (such as PEEK) feed through.

In one embodiment of the present invention, the window and the cathode can be attached to the sealable tube by a flange design. Alternatively, one or both of the cathode and the window may be attached to the sealable tube in a variety of other ways, e.g., by use of a simple O-ring system and compression gasket to hold the window and the cathode in place.

In a presently preferred embodiment, the invention irradiation system is suitable for use under vacuum conditions at high vacuum (i.e., at low pressures) so that it is not necessary for the system to be operated in the glow discharge pressure range for the cathode thermionic filament. The vacuum system can be of one of more stages and can include a roughing pump and a high vacuum pump. Exemplary types of high vacuum pumps can include a diffusion pump, a turbo-molecular pump, an ion gauge pump, a cryogenic vacuum pump or a combination of vacuum pumps that will maintain the vacuum in the system below the glow discharge pressures of the cathode thermionic filament.

Attachment to the source of vacuum can be accomplished through a variety of connectors including KF, conflat flange, a hose nipple, and the like; the resulting connections can be bolted or externally clamped. A simple way to attach the system to the vacuum pump is using a flange (either KF or conflate) and attaching the flange via screws or bolts to an identical flange on the pump system. This will allow ideal alignment of the flange and optimal pumping of the vacuum system.

The invention Ebeam system generally employs some type of control to initiate the electron beam output and to control the voltage and amperage of the system. As readily recognized by those of skill in the art, such control can be accomplished in a variety of ways, e.g., one option is a free standing control system made from standard components and designed to provide control to the Ebeam gun to operate the system and provide electrons from the source. Another option is a computer controlled system. For the computer controlled system an off the shelf program such as Labview can be used and customized to operate the Ebeam system. The computer control can combine the ability to control the output with feedback information about the performance of the system not available with the free standing control system.

The invention will now be described in greater detail by reference to the following non-limiting example.

### Example 1

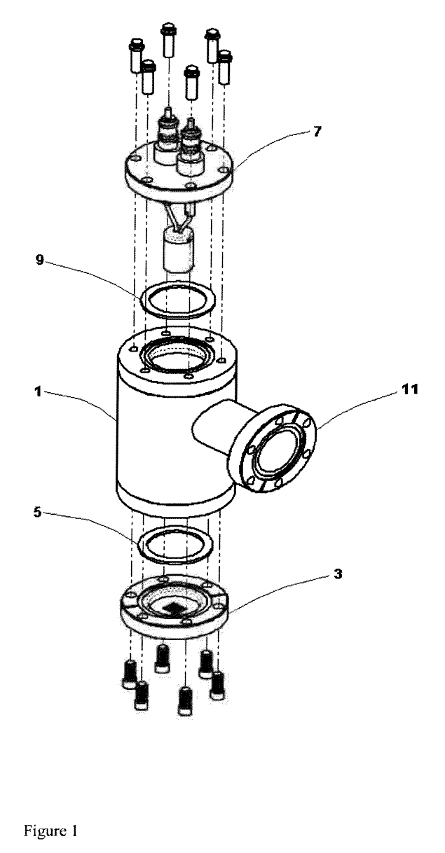

In FIG. 1, the front window flange (3) is mounted to the housing (1) with 6 bolts and set into the housing with an O-ring (5) of appropriate material. The sealable tube housing (1) has the vacuum flange (11) at 90° to the Ebeam sealable tube body. The filament assembly (7) is mounted to the sealable tube (1) with a flange that contains a high voltage feed through. The flange is mounted to the sealable tube with a suitable O-ring (9) to hold vacuum and 6 bolts that mount the flange assembly to the gun housing.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, including all formulas and figures, to the same extent as if each were incorporated by reference individually. In case of conflict, the present specification, including definitions, will control.

Other embodiments are set forth within the following claims.

That which is claimed is:

1. An irradiation system comprising:
(a) a sealable tube;
(b) a cathode assembly;
(c) a source of electrical current for said cathode assembly; and
(d) an optional window assembly;
wherein said sealable tube has at least one opening for receiving said cathode assembly, at least one vacuum port, and optionally, at least one opening for receiving said window assembly,
wherein said cathode assembly is reversibly attachable to said scalable tube,
wherein said source of electrical current is reversibly attachable to said cathode assembly, and
wherein said window assembly, when present, is reversibly attachable to said sealable tube.

2. The irradiation system of claim 1, wherein the irradiation system has output energy of 0.001 to 1 million electron volts.

3. The irradiation system of claim 1, wherein the window assembly is not present.

4. The irradiation system of claim 3, wherein the irradiation system is operated in a vacuum.

5. The irradiation system of claim 1, wherein the window assembly is present.

6. The irradiation system of claim 5, wherein the window assembly is comprised of materials suitable for electron transmission.

7. The irradiation system of claim 6, wherein the materials suitable for electron transmission are selected from the group consisting of metallic elements, non-metallic elements, organic compounds, inorganic compounds, and conducting polymers.

8. The irradiation system of claim 7, wherein the metallic elements are selected from the group consisting of aluminum, titanium, silicon, and tantalum.

9. The irradiation system of claim 7, wherein the non-metallic elements are selected from the group consisting of carbon, graphite, diamond, and diamond-like carbon.

10. The irradiation system of claim 7, wherein the organic compounds are selected from the group consisting of mylar and kapton, as well as metalized versions thereof.

11. The irradiation system of claim 7, wherein the inorganic compounds are selected from the group consisting of mica, boron nitride, silicon carbide, alumina, garnet, sapphire, ruby, magnesium fluoride, calcium fluoride, synthetic fused silica, doped synthetic fused silica, and silicon dioxide, as well as metalized versions thereof.

12. The irradiation system of claim 7, wherein the conducting polymers are selected from the group consisting of polythiophene, polyaniline, and polyacetylene.

13. The irradiation system of claim 5 wherein the thickness of the window material falls in the range of about 0.05 microns up to about 20 microns.

14. The irradiation system of claim 1, wherein the sealable tube is comprised of materials suitable for vacuum application.

15. The irradiation system of claim 14, wherein said materials suitable for vacuum application are selected from the group consisting of metals, ceramics and composites.

16. The irradiation system of claim 1, wherein said cathode assembly comprises an electron source, and one or more beam forming electrodes comprised of vacuum compatible materials.

17. The irradiation system of claim 16, wherein said electron source is prepared from tungsten, tantalum or other alloys.

18. The irradiation system of claim 17, wherein said beam forming electrode(s) are prepared from vacuum compatible metal(s).

19. The irradiation system of claim 1, further comprising a vacuum system.

20. The irradiation system of claim 19, wherein the vacuum system comprises one or more stages selected from the group consisting of:
a roughing or high pressure (low vacuum) portion, and
a low pressure (high vacuum) portion.

21. The irradiation system of claim 20, wherein said high vacuum portion comprises one or more vacuum pumping systems.

22. The irradiation system of claim 21, wherein said vacuum pumping systems are selected from the group consisting of one or more of turbo-molecular vacuum pumps, cryogenic vacuum pumps, diffusion vacuum pumps, sorption vacuum pumps and ion vacuum pumps.

23. The irradiation system of claim 1, wherein the reversible attachment is accomplished employing flanges with metallic gasket/knife edges, O rings, or no flange.

24. The irradiation system of claim 19, wherein the vacuum pump is attached to the vacuum port by way of a hose nipple, bolted flanges or externally clamped flanges.

25. The irradiation system of claim 5, wherein the window design comprises one or more openings of a geometric size, shape and extent suitable to the material employed for the preparation of the window itself.

26. The irradiation system of claim 25, wherein said window design is round, square, triangular, or slotted.

27. The irradiation system of claim 1, wherein the power supply for said cathode assembly comprises a suitable high voltage, high vacuum feed-having the necessary number of through conductors.

28. The irradiation system of claim 1, further comprising an operating system which controls the emission of electrons by said irradiation system.

29. The irradiation system of claim 28, wherein the operating system is operated by computer control or a control module capable of operating the irradiation system.
